(19) United States
(12) Patent Application Publication
(10) Pub. No.: US 2023/0188491 A1
(43) Pub. Date: Jun. 15, 2023

(54) Method and Related Systems for Dynamic Notification Management

(71) Applicant: Ben Iceton, Saffron Walden (GB)

(72) Inventor: Ben Iceton, Saffron Walden (GB)

(21) Appl. No.: 17/548,647

(22) Filed: Dec. 13, 2021

(51) Int. Cl. H04L 51/224; H04L 51/063; H04L 51/42

(52) U.S. Cl. CPC H04L 51/24; H04L 51/063; H04L 51/22

(57) ABSTRACT

The present disclosure provides a method for dynamically managing notifications sent to a plurality of users by a central entity, wherein the notifications are sent to a state-based inbox for each of the recipients, which they can access through a client device. Notifications in the state-based inbox each have an associated state, and the central entity can both recall and update any notification in the plurality of recipient inboxes by sending an update for that notification with an instruction to change the state. Related systems for implementing the disclosed method are also provided herein.

### FIELD OF INVENTION

The present invention relates generally to notification systems and methods. More specifically, the present invention relates to a state-based update messaging method and system for implementing the method.

### BACKGROUND

Various electronic messaging and update systems exist for delivering notifications to the inboxes of multiple users simultaneously. Electronic mail, or e-mail, is the most widespread of these systems, and is used to transmit and receive messages over a communications network (e.g., Internet). Other examples include dedicated messaging platforms such as Microsoft Teams, as well as mobile push notifications.

Such systems are particularly useful in enterprise activities where it is common for an update to need to be shared with many members of the enterprise at once. A central entity can determine that an update needs to be shared with some or all members of the enterprise, and the notification is pushed to the inboxes of those users, which they can access using e-mail-enabled electronic or client devices (e.g., computers, tablets, phones).

Some users can receive several hundred e-mail messages in a day. Unless regularly managed, a user's mailboxes or folders (e.g., inbox, archive, deleted items) can become overrun with saved e-mail messages. Many of those saved e-mail messages may no longer be useful and/or important to the user. This is particularly true for mass-distributed enterprise updates, which often relate to matters that are only relevant for a particular time window or to problems which are quickly solved. Furthermore, once such updates are sent out, there is no way for the sending entity to recall them once it is known that the update is no longer relevant.

Some conventional e-mail programs allow for the automated deletion of e-mail messages to help organize, reduce mailbox clutter, and/or reduce the user's time in organizing e-mail mailboxes or folders. However, in these conventional programs, the automated deletion is based on static rules established by the sending party at the time of sending and/or by the recipient of the e-mail as a continuous rule. While this may save time in the future or back end, it requires users of the e-mail software to establish the rules for deleting the e-mail before sending—which in turn requires additional time and/or review before sending the e-mail. A universal auto-deletion time cannot be applied because the time that different updates are relevant to end users will vary.

It is within this context that the present invention is provided.

### SUMMARY

The present disclosure provides a method for dynamically managing notifications sent to a plurality of users by a central entity, wherein the notifications are sent to a state-based inbox for each of the recipients, which they can access through a client device. Notifications in the state-based inbox each have an associated state, and the central entity can both recall and update any notification in the plurality of recipient inboxes, manually or automatically, by sending an update for that notification with an instruction to change the state. Related systems for implementing the disclosed method are also provided herein.

Thus, according to one aspect of the present disclosure there is provided a computer-implemented method of dynamically managing notifications directed to a plurality of users, the method comprising the steps of: receiving, by a server, a notification request, the notification request comprising user data indicating a plurality of recipients for a notification and notification content; distributing, by the server, to a plurality of client devices each having access to a state-based inbox associated respectively with the plurality of recipients, a notification tagged as having a first state and containing the notification content; receiving, by the server, an update request, the update request comprising data specifying a second state for the notification; and distributing, by the server, to the plurality of client devices, instructions to update the state of the notification in the state-based inboxes to the second state.

In some embodiments, the update request is a deletion request and the second state is an inactive state, and wherein receipt of the update request by a client device causes the client device to remove the notification from the state-based inbox.

Upon receipt of the deletion request, each client device may check the state-based inbox to determine whether the original notification has already been dismissed or removed by a user.

In some embodiments, the update request is an archive request and the second state is an archived state, and wherein receipt of the update request by a client device causes the client device to store the notification in a hidden archive folder of the state-based inbox.

Upon receipt of the archive request, each client device may check the state-based inbox to determine whether the original notification has already been archived, dismissed, or removed by a user.

In some embodiments, the update request further comprises a notification having updated notification content and the second state is an updated state, and wherein receipt of the update request by a client device causes the client device to remove the original notification from the state-based inbox and replace it with the updated notification content.

The first state may be an active state.

The notification request and update request may be received from an enterprise notification system and the plurality of client devices may each be associated with the enterprise.

According to another aspect of the present disclosure, there is provided a system dynamically managing notifications directed to a plurality of users, the system comprising: a plurality of client devices, each client device having access to a state-based inbox; a notifying entity configured to generate notification requests and update requests directed to one or more state-based inboxes.

The system further comprises one or more servers in wireless or wired communication with the plurality of client devices and the notifying entity, the one or more servers being configured to carry out the method of any one of the above-described embodiments.

### BRIEF DESCRIPTION OF THE DRAWINGS

Various embodiments of the invention are disclosed in the following detailed description and accompanying drawings.

FIG. 1 illustrates a flow diagram of a set of steps for implementing the disclosed method.

FIG. 2 illustrates an example network architecture and system over which the disclosed method may be implemented.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a state-based notification and update system wherein a central update entity such as a local enterprise server or cloud server distributes updates to a plurality of recipient inboxes which are state-based, meaning that each notification stored in the inbox has an associated state, and wherein changes to the associated state cause the notification to be updated, archived, or removed from the inbox.

This allows users, and in particular enterprises, to generate system updates that only remain in a user's inbox while they are relevant, and to either update the information as the situation to which the notification pertained changes, or to delete the notification once the original notification is deemed to no longer be relevant at all.

The method can be implemented using tradition email protocols, platform specific messaging services, or via push updates to client devices.

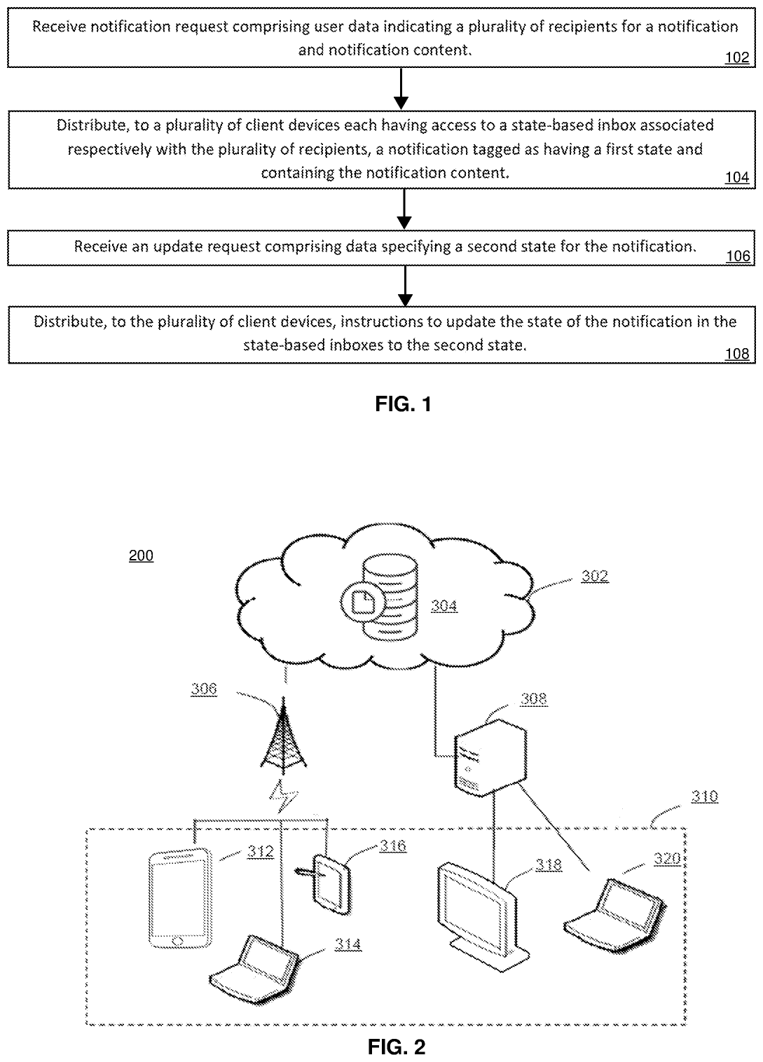

Referring to FIG. 1, a flow diagram comprising a set of steps for implementing the disclosed method is shown.

In a first step 102, the method involves receiving a notification request comprising user data indicating a plurality of recipients for a notification and also comprising notification content.

For example, the notification request may be generated by an administrative manager for an enterprise computer system. In such an example, the notification content might be information pertaining to a scheduled downtime for the enterprise servers, which will prevent members of the enterprise from utilising the enterprise servers at the scheduled time.

The notification content may thus read:
“We want to make you aware that this Friday (18 June) at 6.30 PM BST, there will be scheduled downtime of the local network for approximately 2 hours. We will be using this time to add more capacity to Company A servers and make infrastructure changes. Access to the enterprise systems will not be available during this time period.”

Enterprise users receive many such updates, and they usually end up clogging inboxes unless the inboxes are constantly managed by the users.

The plurality of recipients specified in the notification request would be any and all individuals likely to be affected by the scheduled downtime, i.e. all members of the enterprise.

The above situation is an example of a type of manually generated notification that could be managed via the disclosed method, however automatically generated notifications can also be integrated, such as messages generated by pre-existing enterprise systems.

Even messages similar to the administrative manager's notification above could be automatically generated in a large organisation. Such organisations experience multiple incidents on a daily basis, each with differing severity and impact on the business. Notifications sent to the entire organisation can often backfire since, in addition to the impact of the problem itself, it can also result in users calling the helpdesk or support team to report the issue or get an update, inundating the support teams preventing them from resolving the issue.

Another example of a widely used type of automated notification requiring action from a recipient is approvals. The requirement for approvals across the average enterprise structure is considerable, spanning IT, Finance, HR and operations.

Many systems have been developed for generating and managing approvals, and many such solutions have dedicated portals for users to log in, view the details of, and action the approvals. But users are not always connected to these systems and thus rely on emails to alert them when approvals require their attention. Like many other essential emails, these are often missed due to the volume of email clogging their inboxes.

The disclosed method and systems may integrate with the pre-existing approval management systems (and other pre-existing enterprise systems) so that when an approval request is created it is passed to the system implementing the disclosed method and converted into an actionable notification request as defined in step 102 by applying a state to it. The notification request may be populated with content from the original automatically generated approval request, and can thus be configured to include different feedback options such as buttons, i.e. Approve/Reject, Comment fields, Surveys etc. The target recipient of set of recipients would also be populated from the original request.

Naturally, in addition to the examples above, general enterprise communications such as newsletters can also be managed by the disclosed method.

In a second step 104, the method involves distributing, to a plurality of client devices each having access to a state-based inbox associated respectively with the plurality of recipients, a notification tagged as having a first state and containing the notification content.

Thus, the message of the administrative manager shown above would be sent to each of the enterprise users' state-based inboxes, accessible by their respective client devices, with an “active” status tag.

Approval requests would be sent to either a specific recipient or any number of recipients identified in the system as having the requisite authority to approve or reject the approval.

In a third step 106, the method involves receiving an update request comprising data specifying a second state for the notification. Depending on the type of update, this can trigger different types of workflows.

In one example, the update request may indicate that the original notification is no longer relevant. Such as if the scheduled down time has now been completed and access to the enterprise servers is restored.

For approvals, and other such actionable notifications, the update request may indicate that a recipient has applied the appropriate action to the request, i.e. approving or rejecting it. For example, the users can either click a link back to the record in the originating system or approve directly in the notification. Operators can configure workflows to send new or retract existing messages from other users based on interaction from a user. Examples of this could include delegating to other users, a multi-stage approval or requesting more information for approval.

Enterprise users for the most part do not need to know about past maintenance downtime windows, so the administrator may send a recall or deletion request indicated that the state of the original notification should be changed to inactive.

Alternatively, if an organisation prefers to provide its users with access to a history of such notifications, the update request may instead of causing the notification to be deleted from the state-based inbox, cause it to be archived in a hidden archive folder of the inbox which a user may access to view the update and other previous updates.

In another example of the administrative manager's notification, the update request may indicate that the information contained in the original notification is no longer applicable, but that instead of being deleted, the original notification should be updated with new notification content. Such as if the scheduled window for the downtime has increased due to a change in the scope of the work. New notification content may be sent along with the update request in this case.

For example, the updated notification content may read:
“We want to make you aware that this Friday (18 June) at 5.30 PM BST, there will be scheduled downtime of the local network for approximately 4 hours. We will be using this time to add more capacity to Company A servers and make infrastructure changes. Access to the enterprise systems will not be available during this time period.”

In a fourth step 108, the method involves distributing, to the plurality of client devices, instructions to update the state of the notification in the state-based inboxes to the second state.

Updating the state of the original notification can cause it to be removed from or archived in the inbox if it is no longer relevant and a deletion or archive request was sent, or to be replaced with an updated notification as shown above.

Upon receipt of a deletion or archive request, each client device may check the state-based inbox to determine whether the original notification has already been archived, dismissed or removed by a user before changing the state.

The disclosed method thus prevents accumulation of irrelevant and redundant notifications in a user's inbox, reducing the amount of time and mental effort required to keep an inbox in good order and increasing efficiency.

Referring to FIG. 2 an example network architecture 200 is shown over which the disclosed method can be implemented.

One or more of the operations and calculations described herein may be performed by a cloud infrastructure 302 comprising one or more servers and databases 304. Alternatively it may be implemented by a local enterprise server.

The cloud infrastructure 302 may for example comprise a database configured to receive and store user data for a plurality of user accounts and a set of servers or nodes configured to enact the operations as disclosed herein.

The cloud infrastructure 302 is configured to communicate with a set of client devices 310 by various means over the illustrated network architecture. The illustrative client devices 310 include devices configured to communicate with the cloud infrastructure 302 via a communications tower 306. These devices may include but are not limited to a smartphone 312, a laptop 314, and a tablet computer 316.

Additional client devices configured to communicate with the cloud infrastructure 302 via a networked computer modem 308 include but are not limited to a smart display 318 and a second laptop 320. Some of the connections may be wired connections, such as the connection between the smart display 318 and the networked computer modem 308.

Any one of the client devices 310 may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes illustrative communication tower 306.

While a specific set of client devices are illustrated in the architecture of FIG. 2 the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Each client device 310 may be associated with or “logged in” to a user profile in order to operate within the disclosed system and method, and further configured to send requests, upload user data, and generally interact with the cloud infrastructure 302 via a user interface displayed on the device.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and system for state-based notifications have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method of dynamically managing notifications directed to a plurality of users, the method comprising the steps of:
receiving, by a server, a notification request, the notification request comprising user data indicating a plurality of recipients for a notification and notification content;
distributing, by the server, to a plurality of client devices each having access to a state-based inbox associated respectively with the plurality of recipients, a notification tagged as having a first state and containing the notification content;
receiving, by the server, an update request, the update request comprising data specifying a second state for the notification; and
distributing, by the server, to the plurality of client devices, instructions to update the state of the notification in the state-based inboxes to the second state.

2. A computer-implemented method according to claim 1, wherein the update request is a deletion request and the second state is an inactive state, and wherein receipt of the update request by a client device causes the client device to remove the notification from the state-based inbox.

3. A computer-implemented method according to claim 2, wherein upon receipt of the deletion request, each client device checks the state-based inbox to determine whether the original notification has already been archived, dismissed, or removed by a user.

4. A computer-implemented method according to claim 1, wherein the update request is an archive request and the second state is an archived state, and wherein receipt of the update request by a client device causes the client device to store the notification in a hidden archive folder of the state-based inbox.

5. A computer-implemented method according to claim 4, wherein upon receipt of the archive request, each client device checks the state-based inbox to determine whether the original notification has already been archived, dismissed, or removed by a user.

6. A computer-implemented method according to claim 1, wherein the update request further comprises a notification having updated notification content and the second state is an updated state, and wherein receipt of the update request by a client device causes the client device to remove the original notification from the state-based inbox and replace it with the updated notification content.

7. A computer-implemented method according to any preceding claim, wherein the first state is an active state.

8. A computer-implemented method according to any preceding claim, wherein the notification request and update request are received from an enterprise notification system and wherein the plurality of client devices are each associated with the enterprise.

9. A system dynamically managing notifications directed to a plurality of users, the system comprising:
a plurality of client devices, each client device having access to a state-based inbox;
a notifying entity configured to generate notification requests and update requests directed to one or more state-based inboxes; and
one or more servers in wireless or wired communication with the plurality of client devices and the notifying entity, the one or more servers being configured to carry out the method of any one of claims 1 to 8.
